(19) United States
(12) Patent Application Publication
(10) Pub. No.: US 2024/0230698 A1
(43) Pub. Date: Jul. 11, 2024

(54) TAYLOR CONE EMITTER DEVICE AUTOMATED HANDLER, TAYLOR CONE EMITTER DEVICE AUTOMATED HANDLING SYSTEM, AND METHOD FOR ANALYZING A SAMPLE

(71) Applicant: RESTEK CORPORATION, Bellefonte, PA (US)

(72) Inventors: Shane C. STEVENS, State College, PA (US); Brandon A. TARR, State College, PA (US); Matthew LININGER, Howard, PA (US); Tracey A. PETERS, Belletonte, PA (US); Ryan MICKLITSCH, Jersey Shore, PA (US); Diego A. LOPEZ, State College, PA (US); Heidi NYMAN, Howard, PA (US); Thomas E. KANE, Bellefonte, PA (US); German A. GOMEZ-RIOS, San Jose, CA (US)

(21) Appl. No.: 18/558,426

(22) PCT Filed: May 3, 2022
(86) PCT No.: PCT/US2022/027460

§ 371 Date: Nov. 1, 2023

Related U.S. Application Data
(60) Provisional application No. 63/183,240, filed on May 3, 2021.
(60) Provisional application No. 63/183,281, filed on May 3, 2021.

(51) Int. Cl. G01N 35/00; B01L 3/02; B01L 9/00; H01J 49/16

(52) U.S. Cl. CPC G01N 35/0099; B01L 3/0275; B01L 9/543; H01J 49/165; B01L 2200/025

(57) ABSTRACT

A Taylor cone emitter device automated handler is disclosed including an actuated Taylor cone emitter device manipulator, first, second, and third actuators configured to actuate the device manipulator horizontally, vertically, and between a vertical orientation and a horizontal orientation. The device manipulator includes a shaft, an emplacement configured to removably engage a receptacle mount of a Taylor cone emitter device, an ejector configured to dismount the receptacle mount, and a clocking feature interface configured to guide the Taylor cone emitter device into and fix it in a predetermined radial orientation. The Taylor cone emitter device automated handler is configured to mount the Taylor cone emitter device in the vertical orientation, rotate the Taylor cone emitter device to the horizontal orientation, and present the Taylor cone emitter device to an analytical instrument. A handling system and method for analyzing a sample using the Taylor cone emitter device automated handler are disclosed.

### RELATED APPLICATIONS

This application claims the benefit of and priority to U.S. Provisional Patent Application No. 63/183,240, filed May 3, 2021, entitled “A Container-Multiwell Plate Assembly for Housing Solid Phase Microextraction Devices,” and U.S. Provisional Patent Application No. 63/183,281, filed May 3, 2021, entitled “Apparatus and Method for Analyzing a Sample,” which are hereby incorporated by reference in their entirety.

### FIELD OF THE INVENTION

This application is directed to Taylor cone emitter device automated handlers, Taylor cone emitter device automated handling systems, and methods for analyzing samples with Taylor cone emitter device automated handlers. In particular, this application is directed to Taylor cone emitter device automated handlers, Taylor cone emitter device automated handling systems, and methods for analyzing samples with Taylor cone emitter device automated handlers in which the Taylor cone emitter device automated handlers transition the Taylor cone emitter devices between a vertical orientation and a horizonal orientation.

### BACKGROUND OF THE INVENTION

### Taylor Cone Emitter Devices

Taylor cone emitter devices are devices capable of creating a Taylor cone in the presence of a liquid and under the influence of an electric field. The Taylor cone may contain the chemical analyte species of interest. Taylor cone emitter devices include coated electrospray needles, coated blade spray devices (described below), sorbent coated electrodes, SPME tips, and porous formed probes, among others.

“Electrical surface charges” are charges generated on a surface when a voltage is applied to the emitter or conductor. Surface charge concentrates at regions with the highest curvature. Therefore, a sharp edge or pointed tip may be used to increase the local charge density. The electric field on the surface (which may be metallic, polymeric, or other) results from the surface charge and is perpendicular to the surface, and its strength is proportional to the surface charge density. The electric field gradient is the rate at which the electric field falls off, and it is strongest on such edges and lines and points. Regions of high electric field gradient are most likely to generate Taylor cones from applied solvent.

Preferably, the Taylor cone is localized in a specific region of the emitter, typically where the cone released from the emitter is positioned to facilitate collection of ionized particles generated from the cone into a mass spectrometer or other ionized particle analyzer.

Taylor cone emitters comprise a shape capable of producing a region of high electric field gradient to create a Taylor cone.

To localize Taylor cones, the emitter device shapes may include, but do not necessarily have, regions having a small radius of curvature, such as sharp points or edges. Localized electric fields are also achieved with protrusions having thin cross sections, narrow diameters, or high aspect ratios as in the case of rods or cones.

Taylor cone emitters may be produced from a single material (substrate) or more than one material in the form of layers or coatings where at least a portion of the uppermost surface serves to collect and release analyte compounds.

Suitable analyte collection materials may collect chemical analytes from a bulk sample. The collection mechanism may be adsorption, dissolution, absorption, or specific binding (e.g., antigen-antibody binding, pore shape and size selection such as metal organic frameworks).

The native uppermost surface of the emitter may serve as an analyte collection material, or analyte collection material may be applied to the uppermost surface. Known applied materials include sorbent beds created with particles and irregular or conformal contiguous coatings. The analyte collection material may be porous or nonporous. The collection material may be permeable or nonpermeable. Typically, the collection material is chemically compatible with the sample and the solvent employed to product the Taylor cone.

### Coated Blade Devices

Coated Blade Spray (“CBS”) is a solid phase microextraction (“SPME”)-based analytical technology previously described in the literature (Pawliszyn et al.; U.S. Pat. No. 9,733,234) that facilitates collection of analytes of interest from a sample and the subsequent direct interface to mass spectrometry systems via a substrate spray event (i.e., electrospray ionization). Solid phase microextraction devices are a form of Taylor cone emitter device typically characterized by having a substrate suitable for retaining a sample. CBS devices typically have regions having a small radius of curvature, such as sharp points or edges.

“Coated blade spray,” “CBS blade,” and “blade device” are used synonymously herein. CBS blades may include, but are not limited to, magnetic CBS blades.

There are two basic stages to CBS-based chemical analysis: (1) analyte collection followed by (2) instrumental analysis. Analyte collection is performed by immersing the sorbent-coated end of the blade device directly into the sample. For liquid samples, the extraction step is generally performed with the sample contained in a vial or well plate.

After analyte collection, the blade device is removed from the sample, and, following a series of rinsing steps, the blade device is then presented to the inlet of the mass spectrometer (“MS”) for analysis. In this fashion, the blade device undergoes several transfer steps. Reliable positioning of the blade device for each of these steps is therefore important, both for manual and robotic automation handling circumstances.

As a direct-to-MS chemical analysis device, the blade device requires a pre-wetting of the extraction material so as to release the collected analytes and facilitate the electrospray ionization process (formation of a Taylor cone). Subsequently, a differential potential is applied between the non-coated area of the substrate and the inlet of the MS system, generating an electrospray at the tip of the CBS device. The electric field between the blade and the MS system must be reproducibly created in order to ensure reliable run-to-run precision. Proper positioning of the blade device with respect to the MS inlet is therefore very important, including the radial (or rotational) orientation of the blade device.

In general, the blade portion of a blade device has two sides, an upper and a lower. In some cases, different sorbent coatings may be present on each of the flat sides of the blade, and two sample analyses may be therefore performed in sequence: first the analysis of the upper side, followed by a second analysis of the lower. In other examples, same sorbent coating may be present on each of the flat sides of the blade, and a two sample analyses may be therefore performed in sequence, but in different instruments: first the analysis of the upper side on instrument A, followed by a second analysis of the lower on instrument B. In either case, the radial orientation of the blade is also critical.

Previous disclosures describe manually handling the individual blade devices to properly position them with respect to the entrance to the mass spectrometer. Other examples describe one- and two-dimensional arrays of blade devices in a bulk holder. These embodiments include a rigid support capable of housing more than one blade device. Examples of this arrangement include U.S. Pat. No. 7,259,019. These examples are generally aligned to the standard laboratory sampling plasticware, most commonly microtiter array trays having an 8×12 well arrangements, the wells having approximately 9 mm centers. Higher density trays are also commercially available, having smaller sample wells positioned even closer together in order to maintain the standard sample tray footprint.

Because of the single inlet to the MS device, the sample analysis stage is still a serial process when using these array-based designs. A selected blade device within the greater array is positioned for electrospray ionization. This design has the disadvantage of also positioning the entire array of blade devices in the general proximity of the MS, which creates considerable risk of electrical and/or chemical cross talk between adjacent blade devices during the electrospray ionization processes. This, in turn, particularly undermines chain-of-custody sample analysis applications, such as clinical or forensic screening of biological fluids.

PCT Application PCT/US2020/047201, incorporated herein by references and which entered the national phase in the U.S. and published as U.S. Patent Application No. 2021/0055192, advanced the state of the art by disclosing CBS devices where the close position array arrangement is maintained during the sample extraction processes using standard microtiter array trays, and where individual blade devices are introduced to the ionization region of the mass spectrometer. along with maintaining radial positioning of the blade during the entire sampling-to-analysis process.

### Description of a Micro Pipettor Device

A common tool in laboratories for transporting accurate volumes of liquid is a micropipettor. Examples of this arrangement include U.S. Pat. Nos. 4,284,604, 5,650,124, and 7,421,913. Micropipettors employ a variety of mechanisms to pull liquid volumes into the device and subsequently dispense the liquid. Precision volume capacities for standard pipettors range from 0.1 μL to 10 mL. In order to reduce the risk of sample contamination, disposable pipette tips are employed. The micropipette tips are mounted onto the pipettor by pushing the pipettor into the tip, and friction maintains the tip in place. After the liquid has been dispensed, the tip is ejected off the end of the pipettor, and the entire process is repeated.

In cases where many liquid transfer steps are performed for highly parallel processes, micropipettor devices employing more than one liquid dispensing channel are available. Examples of this arrangement include U.S. Pat. No. 5,021,217. These devices still employ the friction fit attachment mechanism of the disposable tips.

For clarity, the terms “pipette,” “pipettor,” “micropipettor,” and “multichannel pipettor” are used herein synonymously. The terms “pipette tip” and “micropipette tip” are also used synonymously.

Equivalent liquid volumes are drawn and delivered for each tip. Tip position in the pipettor array aligns with the tip positions in storage racks for ease of installation.

Multichannel pipette devices are used with pipette tips in 1- and 2-dimensional array storage racks, so a row of disposable tips can be mounted in parallel into the micropipettor.

Micropipettor technology has also been adapted to robotic systems, where the entire liquid transfer sequence is the same as employed for the manual units but is automated.

Because of the ubiquitous presence of micropipettors in laboratories, both for manual use and integrated into robotic automation setups, maintaining compatibility with the CBS device to the physical dimensions of micropipettor technology is advantageous.

### Micropipette Tips

Because many applications that employ micropipettors are sensitive to chemical contamination, disposable, single use pipette tips are available. Standard micropipette tips are loaded onto the pipettor device by centering the device over the docked tip and tapping the device gently onto the opening of the tip. The tip is mounted via friction and is ready for use. Following use, the dirty microtiter tip is removed from the device by means of a tip ejector, typically a slidable sheath around the shaft of the device that engages with the upper lip of the disposable tip and pushes to overcome the friction connection. An example of a pipette tip that has been modified for sample extraction includes U.S. Pat. No. 7,595,026.

Common micropipette tips are conical and do not have a radial orientation requirement for normal operation.

Conductive tips are used to prevent carryover in automated pipetting robots. An example of a conductive tip is the addition of graphite to the raw material polypropylene which makes the pipette tips electrically conductive and gives the tips an opaque black appearance. Alternative embodiments where a portion of the pipette tip is conductive are described in U.S. Pat. No. 9,346,045. The relative position of the tips within robotic workstations is identified by measuring electric capacitance. The filling level of the liquid in the tip can be determined in sample and reagent containers by measuring electric currents, so that the depth of immersion of the tip can be adjusted to the filling level.

Because of the frequent tip replacement in standard sampling handling practices, multiple tips are stored in racks where the tips are protected from environmental contamination. In keeping with the array position standards described earlier, bulk storage of disposable tips commonly employs the 8×12, 96 tip arrays or multiples of 96 tips with the standard tip center-to-center position. This allows for direct loading into multichannel pipette devices and maintains the standard rack footprint in laboratories and on the automation workstation platforms.

Rack containers for housing micropipette tips do not include elements to maintain the radial orientations of the standard pipette tips.

### Microtiter Array Trays

Industry standard microtiter array trays (also referred to as “microtiter plates,” “microplates,” “microwell plates,” and “multiwells”) are formed according to ANSI SLAS 1-2004 (R2012), “Microplate Footprint Dimensions,” ANSI SLAS 2-2004 (R2012), “Microplate Height Dimensions,” ANSI SLAS 3-2004 (R2012), “Microplate Bottom Outside Flange Dimensions,” ANSI SLAS 4-2004 (R2012), “Microplate Well Positions,” and ANSI SLAS 6-2012, “Microplate Well Bottom Elevation.” Microtiter array trays are often docked or otherwise engaged with laboratory equipment, whereby the wells are accessed by automation. Common automation processes accessing microtiter wells include liquid dispensing. In many automation systems, multiple microtiter array trays are docked, requiring precise knowledge of the well positions with respect to each other as well as to neighboring microtiter array trays. The microtiter array tray has standardized values for tray length and tray width. Microtiter array trays may optionally have a tray wall recessed from the tray skirt. Industry standard dimensions are 127.71 mm length by 85.43 mm width by 14.10 mm height. Microtiter array trays commonly comprise 6 (2×3), 12 (3×4, 24 (4×6), 48 (6×8), 96 (8×12), or 384 (16×24) wells of varying volume, as well as other arrays described in the standards. The volume is determined by the number, size and depth of the wells. The tray footprints of these microtiter trays are specified in the related ANSI standards.

### MS Analysis

In recent years, several new direct-to-MS technologies have been developed aiming to shorten analysis turnaround time (“TAT”), which, in the case of clinical analysis, is the time it takes from the reception of the sample by the analyst to the delivery of the analytical result to the physician. Among this new set of technologies, MS technologies without the use of a chromatographic separation step and a sample preparation step have proven to be the most successful in TAT reduction. However, most of these technologies are limited with respect to quantitation and robustness of the instrumentation over time. One approach taken, aiming to improve sensitivity at the expense of time, is the use of simple sample preparation approaches prior to the direct interface with mass spectrometry. Among the sample preparation tactics explored so far, those that can be easily miniaturized have been the most efficient. Analyte collection/extraction may be performed either onto a liquid phase extracting material (e.g., an organic solvent) or onto a solid phase extracting material (e.g., a polymeric material). In the case of extracting materials in solid phase, micro-solid phase extraction (“μSPE”), disperse solid phase extraction (“dSPE”), magnetic solid phase extraction (“mSPE”), open bed SPE (“oSPE”), solid phase microextraction (“SPME”) and magnetic SPME (“mSPME”) have been most commonly used strategies. There is not always a clear technical differentiation between oSPE and SPME methods, or between magnetic mSPME and mSPE methods. Herein, SPME, μSPE, mSPME, and mSPE are therefore used synonymously.

SPME directly interfaced with mass spectrometry instrumentation has surged as means to improve the performance of either existing direct to MS technologies or SPME methods directly hyphened with MS via chromatographic separations. When compared to chromatographically based methods, direct-to-MS couplings typically focused on improving at least one of turnaround time, sensitivity, simplicity, or cost-per-sample.

SPME-MS developments may be classified based on either the analyte ionization mechanism (e.g., electrospray ionization (“ESI”)), the analyte desorption/elution mechanism (i.e., liquid-, thermal- or laser-based methods), the material used to manufacture the sampling device and/or the extracting phase, the application where the microextraction devices have been implemented. ESI is a technique traditionally used in combination with liquid chromatography (“LC”) to generate ions for MS. Conventionally, a liquid carrying the analytes of interest is pumped to the ionization source (e.g., a stainless steel capillary) where an aerosol spray is formed by the application of an excitation voltage differential potential between a stainless steel capillary and the mass spectrometer inlet. In most cases, the excitation voltage comprises a few thousands of volts. With aid of nebulizing gas, solvent droplets from the spray undergo rapid solvent evaporation prior to the inlet of the mass spectrometer, releasing ions to the gas phase for analysis in the mass spectrometer. Most ESI sources commercially available also use heat to increase the efficiency of desolvation. The sensitivity of ESI-MS is determined by the efficiency of producing gas-phase ions from analyte molecules in charged droplets (ionization efficiency) and the effective transfer of the charged species from the atmospheric pressure ion source to the high-vacuum MS analyzer (ion transmission efficiency). Nano-electrospray ionization (nano-ESI) is widely recognized as the most efficient method of introducing a liquid sample for direct analysis by mass spectrometry. The technique is distinguished from more conventional forms of electrospray by the fashion in which it is carried out. One to two microliters of sample are deposited into a glass or quartz tube that has a tip diameter in the order of 1 μm and is sprayed from the tip by applying a voltage to the solution. The actual flow rate is usually a few nL/min to a few tens of nL/min, controlled by the diameter of the tip, the voltage applied, and the backpressure that is sometimes applied to the tube content. Nano-ESI reduces interference effects from salts and other species and provides better sensitivity toward a variety of analytes, including peptides and oligosaccharides, in samples contaminated by high levels of salts. Ionization efficiency is attributed to the reduced droplet size compared with electrospray at higher flow rates.

Substrate spray ionization is a type of ESI where ions are generated from a solid substrate, such as a leaf or a piece of paper, by applying a high electrical differential potential between said substrate and the mass spectrometer inlet on a sufficiently wet substrate so to generate a Taylor cone. In the case of non-conductive substrates, the potential is directly applied to the solvent. Most of the substrate ESI devices developed to date, where no sample preparation steps are intrinsic of the analytical workflow, have been categorized as ambient ionization technologies (e.g., paper spray ionization). In line with its name, most substrate spray ionization devices reported to date generate an ESI on a fully open environment.

Unlike traditional ESI, the liquid used for electrospray ionization in Taylor cone emitters devices is neither contained on a capillary nor pressurized throughout the capillary. Indeed, the flow of liquid towards the tip of a Taylor cone emitter during the electrospray process predominately relies on gravitational forces (if applied) and the electro-osmotic flow created when applying a potential difference between the tip of the Taylor cone emitter and the inlet of the mass spectrometer (as long as the tip of the Taylor cone emitter is sufficiently wet). As a result, said flow of liquid and the electrospray ionization process itself are more susceptible to the environmental conditions surrounding it.

Cartesian coordinates are an ordered set of numbers that define the position of a point. If the point is on a plane, then two numbers are used. To define the position of a point in a three-dimensional space, three coordinates are required. Furthermore, Euler angles are used to describe the orientation of said rigid body with respect to a fixed coordinate system. Herein, said Cartesian coordinates and Euler angles are expressed in millimeters (mm) and degrees(°), respectively.

There are two basic stages to emitters-based chemical analysis: (1) analyte collection with a Taylor cone emitter on a nominal vertical position, and (2) instrumental analysis with the Taylor cone emitter on a nominal horizontal position. These steps are performed in isolation; analyte collection is performed by immersing the Taylor cone emitter on a nominal vertical position directly into a sample placed on a well plate or vial. In the nominally vertical position, arrays of emitters may alternatively be batch processed during sample collection by transporting multiple emitter arrays and performing the sample collection steps in parallel. The sample analysis step requires an elution solvent to be applied to at least one flat side of the emitter and retained on the surface during the Taylor cone emission. This specification requires the emitter to be positioned in a horizontal or essentially horizontal position to facilitate the retention of the elution solvent. These two position requirements fundamentally separate the two steps from being performed using laboratory standard liquid handling automation. Batch processing during sample collection further distances the two stems, as analysis is performed serially with single emitters, due to the sole MS inlet. Following the analyte collection step, the Taylor cone emitter is either stored in a nominally vertical position in a repository or housing, or advanced directly to the sample analysis step. The Taylor cone emitter is presented to the MS inlet of the mass spectrometer for analysis on a nominal horizontal position.

For effective transmission of the generated ions, the position of the emitter is controlled in two ways: the position of the emitter tip with respect to the MS inlet, and the nominally horizontal position of the flat side of the emitter. The nominally horizontal position of the flat side of the emitter ensures collection and retention of the elution solvent during analysis, and the position of the emitter tip with respect to the MS inlet addresses the electric field requirements generated by the relative different potential between the emitter and the MS inlet, and directs the ions generated by the Taylor cone for effective collection by the MS. Both positions may be represented by a standard x-y-z coordinates; however, due to the planar nature of the flat side of the emitter, additional rotational positions are anticipated, the said rotation is defined by given Euler angles ϕ, ψ and θ, which are respective to said x-y-z coordinates. Such positioning enables optimization of the ion signal both generated by the emitter and collected by the MS, given the design variability of the many MS models commercially available. The electric field between the Taylor cone emitter device and the MS system must be reproducibly created in order to ensure reliable run-to-run precision (i.e. reproducible instrumental signal). Proper positioning of the Taylor cone emitter with respect to the MS inlet opening is therefore very important, including the radial (or rotational) orientation of the Taylor cone emitter.

Different types of motion hardware have been described either to conduct an entire sample preparation workflow or to interface sample the preparation device with chromatographic analytical instrumentation. Liquid handlers employ motion hardware that focuses on transferring small amounts of liquid by means of a pipette tip from one location to another. Commonly, commercially available liquid handlers have been adapted for transporting small devices, such as set of SPME fibers, from one location to another. In these cases, the position of the small devices maintains the nominally vertical position inherent to liquid handling systems.

### BRIEF DESCRIPTION OF THE INVENTION

In one exemplary embodiment, a Taylor cone emitter device automated handler includes an actuated Taylor cone emitter device manipulator, a first actuator configured to horizontally actuate the actuated Taylor cone emitter device manipulator, a second actuator configured to vertically actuate the actuated Taylor cone emitter device manipulator, and a third actuator configured to rotationally actuate the actuated Taylor cone emitter device manipulator between a vertical orientation and a horizontal orientation. The actuated Taylor cone emitter device manipulator includes a shaft, an emplacement disposed at an end of the shaft, the emplacement being configured to removably engage a receptacle mount of a Taylor cone emitter device, an ejector configured to dismount the receptacle mount of the Taylor cone emitter device, and a clocking feature interface configured to guide a clocking feature of the Taylor cone emitter device into a predetermined radial orientation and fix the Taylor cone emitter device in the predetermined radial orientation. The Taylor cone emitter device automated handler is configured to mount the Taylor cone emitter device in the vertical orientation, rotate the Taylor cone emitter device to the horizontal orientation, and present the Taylor cone emitter device to an analytical instrument.

In another exemplary embodiment, a Taylor cone emitter device automated handling system includes an analytical instrument having a sample inlet, a sample loading antechamber mounted to the analytical instrument such that the sample inlet of the analytical instrument is covered by the sample loading antechamber, and a Taylor cone emitter device automated handler. The sample loading antechamber includes a gas purge configured to fill the sample loading antechamber with an inert atmosphere, a sample aperture configured to receive a Taylor cone emitter device, and a high voltage power electrode disposed within the sample loading antechamber and configured to contact the Taylor cone emitter device when the Taylor cone emitter device is in a predetermined position and orientation relative to the sample inlet of the analytical instrument. The Taylor cone emitter device automated handler includes an actuated Taylor cone emitter device manipulator, a first actuator configured to horizontally actuate the actuated Taylor cone emitter device manipulator, a second actuator configured to vertically actuate the actuated Taylor cone emitter device manipulator, and a third actuator configured to rotationally actuate the actuated Taylor cone emitter device manipulator between a vertical orientation and a horizontal orientation. The actuated Taylor cone emitter device manipulator includes a shaft, an emplacement disposed at an end of the shaft, the emplacement being configured to removably engage a receptacle mount of the Taylor cone emitter device, an ejector configured to dismount the receptacle mount of the Taylor cone emitter device, and a clocking feature interface configured to guide a clocking feature of the Taylor cone emitter device into a predetermined radial orientation and fix the Taylor cone emitter device in the predetermined radial orientation. The Taylor cone emitter device automated handler is configured to mount the Taylor cone emitter device in the vertical orientation, rotate the Taylor cone emitter device to the horizontal orientation, insert the Taylor cone emitter device into the sample loading antechamber through the sample aperture, and present the Taylor cone emitter device to the sample inlet of the analytical instrument.

In another exemplary embodiment, a method for analyzing a sample includes mounting a Taylor cone emitter device in a vertical orientation to a Taylor cone emitter device automated handler. The Taylor cone emitter device automated handler includes an actuated Taylor cone emitter device manipulator, a first actuator configured to horizontally actuate the actuated Taylor cone emitter device manipulator, a second actuator configured to vertically actuate the actuated Taylor cone emitter device manipulator, and a third actuator configured to rotationally actuate the actuated Taylor cone emitter device manipulator between a vertical orientation and a horizontal orientation. The actuated Taylor cone emitter device manipulator includes a shaft, an emplacement disposed at an end of the shaft, the emplacement being configured to removably engage a receptacle mount of the Taylor cone emitter device, an ejector configured to dismount the receptacle mount of the Taylor cone emitter device, and a clocking feature interface configured to guide a clocking feature of the Taylor cone emitter device into a predetermined radial orientation and fix the Taylor cone emitter device in the predetermined radial orientation. The method further includes rotating the Taylor cone emitter device to the horizontal orientation, inserting the Taylor cone emitter device into a sample loading antechamber through a sample aperture of the sample loading antechamber, the sample loading antechamber being mounted to an analytical instrument such that a sample inlet of the analytical instrument is covered by the sample loading antechamber. The sample loading antechamber includes a gas purge configured to fill the sample loading antechamber with an inert atmosphere. The sample aperture is configured to receive the Taylor cone emitter device. The sample loading antechamber further includes a high voltage power electrode disposed within the sample loading antechamber and configured to contact the Taylor cone emitter device when the Taylor cone emitter device is in a predetermined position and orientation relative to the sample inlet of the analytical instrument. The method further includes presenting the Taylor cone emitter device to the sample inlet of the analytical instrument at the predetermined position and orientation relative to the sample inlet of the analytical instrument, energizing the high voltage power electrode in contact with the Taylor cone emitter device, collecting ions generated from the Taylor cone emitter device through the sample inlet of the analytical instrument, analyzing the collecting ions with the analytical instrument, and removing the Taylor cone emitter device from the sample loading antechamber.

### BRIEF DESCRIPTION OF THE DRAWINGS

FIG. 1 illustrates a Taylor cone emitter device positioned relative to an inlet of a mass spectrometer, according to an embodiment of the present disclosure.

FIG. 2 illustrates the relevant mechanical elements of a commercially available micropipettor and disposable pipette tip.

FIGS. 3(a)-(c) illustrate a Taylor cone emitter device having fin elements for control of radial orientation while housed in a storage container from a side view (FIG. 3(a)), a front view (FIG. 3(b)), and a perspective view (FIG. 3(c)), according to an embodiment of the present disclosure.

FIGS. 4(a)-(b) illustrate a Taylor cone emitter device repository with three examples of mechanical elements to promote control of the radial orientation of a Taylor cone emitter device having fin elements from a top view (FIG. 4(a)) and a side view (FIG. 4(b)).

FIG. 5 illustrates an example of a Taylor cone emitter device repository with three exemplary properly docked Taylor cone emitter devices having fin elements.

FIGS. 6(a)-(d) illustrate a Taylor cone emitter device automated handler: prior to loading a Taylor cone emitter device (FIG. 6(a)), after loading the Taylor cone emitter device (FIG. 6(b)), after altering the orientation of the Taylor cone emitter device from vertical to horizontal (FIG. 6(c)), and after approaching a sample inlet with the Taylor cone emitter device (FIG. 6(d)), according to an embodiment of the present disclosure.

FIGS. 7(a)-(b) illustrate a Taylor cone emitter device automated handling system after altering the orientation of a Taylor cone emitter device from vertical to horizontal (FIG. 7(a)) and after inserting the Taylor cone emitter device into a sample loading antechamber (FIG. 7(b)), according to an embodiment of the present disclosure.

FIG. 8 illustrates a method for analyzing at least one sample, according to an embodiment of the present disclosure.

FIG. 9 illustrates experimental results from Experiment 1, according to an embodiment of the present disclosure.

FIG. 10 illustrates experimental results from Experiment 2, according to an embodiment of the present disclosure.

Wherever possible, the same reference numbers will be used throughout the drawings to represent the same parts.

### DETAILED DESCRIPTION OF THE INVENTION

In comparison to devices, systems, and methods lacking at least one of the features described herein, the devices, systems, and methods of the present embodiments decrease sample processing and analysis time, increase testing throughput, decrease analytical errors, increase screening efficiency, increase space efficiency, increase precision and reproducibility in positioning of a Taylor cone emitter relative to a MS inlet, increase precision and reproducibility in delivery of a elution/ionization solvent onto a least one location of a Taylor cone emitter, increase precision and reproducibility of excitation voltages, increase precision and reproducibility of timing of differential potentials applied to a Taylor cone emitter, increase efficient cleaning of an MS inlet between injections and a consistent environment surrounding the Taylor cone emitter throughout the analytical workflow, or combinations thereof.

As used herein, “about” indicates a variance of ±20% of the value being modified by “about,” unless otherwise indicated to the contrary.

As used herein, “horizontal” indicates a range including ±15° from absolute horizontal.

As used herein, “vertical” indicates a range including ±15° from absolute vertical.

As used herein, “Taylor cone emitter” includes, but is not limited to, an article capable of forming a Taylor cone, including, but not limited to, a solid phase microextraction device or a CBS device. A Taylor cone emitter device may have, but need not have, a sharp edge or a pointed tip. A solid phase microextraction device is a form of a Taylor cone emitter device, but not all Taylor cone emitter devices are solid phase microextraction devices.

“Analytes of interest” should be understood as any analyte collected on or extracted by the Taylor cone emitter device. In some examples, the analytes of interest are not targeted (i.e., are not explicitly monitored during the selection/detection steps in the mass spectrometer analyzer). “Analyte of interest,” “target analyte” (“TA”) and “compound of interest” should be understood to be synonymous. In some embodiments, a compound of interest may be a “chemical of interest” or a “molecule of interest” or a “molecular tag.”

The expressions “analyte collection,” “analyte extraction,” “analyte enrichment,” and “analyte loading” are intended to be understood as synonymous terms.

The terms “extractive material,” “sorbent,” “adsorbent,” “absorbent,” “polymeric phase,” “polymer sorbent,” “magnetic particles,” “coated magnetic particles,” and “functionalized magnetic particles” are intended to refer materials use to collect the analytes of interest.

Suitable analyte collection materials may collect chemical analytes from a bulk sample. The collection mechanism may be adsorption, dissolution, absorption, specific binding (e.g., antigen-antibody binding, pore shape and size selection such as metal organic frameworks), or combinations thereof.

As used herein, “solid phase microextraction” includes, but is not limited to, a solid substrate coated with a polymeric sorbent coating, wherein the coating may include metallic particles, silica-based particles, metal-polymeric particles, polymeric particles, or combinations thereof which are physically or chemically attached to the substrate. In some non-limiting examples, the solid substrate has at least one depression disposed in or protrusion disposed on a surface of the substrate and said substrate includes at least one polymeric sorbent coating disposed in or on the at least one depression or protrusion. The term “solid phase microextraction” further includes a solid substrate with at least one indentation or protrusion that contains at least one magnetic component for the collection of magnetic particles or magnetic molecules onto the solid substrate.

A native uppermost surface of a Taylor cone emitter may serve as an analyte collection material, or analyte collection material may be applied to the uppermost surface. Examples of applied materials may include sorbent beds created with particles, and irregular or conformal contiguous coatings. The analyte collection material may be porous or nonporous. The collection material may be permeable or nonpermeable.

The term “analyte injection” should be understood as the act of injecting an ion beam onto a mass spectrometer inlet. “Analyte injection” should be understood as a synonym of “electrospray ionization,” “ion ejection,” “ion expelling,” and “analyte spray.”

The terms “mass spectrometer inlet,” “inlet,” “skimmer cone,” “MS injection aperture,” and “mass spectrometer front-end” are used herein synonymously.

The Taylor cone emitter may be any suitable material, including, but not limited to, a metal, a metal alloy, a glass, a fabric, a polymer, a polymer metal oxide, or combinations thereof. The substrate may include, by way of non-limiting example, nickel, nitinol, titanium, aluminum, brass, copper, stainless steel, bronze, iron, or combinations thereof. Similarly, the substrate may include any material used for additive manufacturing, 3D printing, lithography, or circuit manufacturing, such as, but not limited to, silicon wafer, glass fiber reinforced polymer (“fiberglass”), polytetrafhioroethylene, polyimide film, polycarbonate-acrylonitrile butadiene styrene (“PC-ABS”), polybutylene terephthalate (“PBT”), polylactic acid, poly(methyl methacrylate), polycarbonate (“PC”), acrylonitrile butadiene styrene (“ABS”), polyetherimide (e.g., ULTEM), polyphenylsulfone (“PPSF”), polycarbonate-ISO (“PC-ISO”), or combinations thereof.

The phrase “excitation voltage” should be understood as the voltage necessary to expel and generate, via electrospray ionization mechanisms or atmospheric pressure chemical ionization mechanisms, a stable beam of ions from the substrate electrospray emitter. Excitation voltage may range from a few volts to hundreds or even thousands of volts depending on multiple variables including Taylor cone emitter composition, location of the Taylor cone emitter on regards to the mass spectrometer inlet and the characteristics of the environment at which the electrospray is generated. The excitation voltage ranges between 0.1V and 8,000 V, alternatively between 1,500 and 5,500 V, alternatively between 2,000 and 4,000 V. The excitation voltage may be delivered by different sources such as an alternative current supply, direct current supply, or combinations thereof. The excitation voltage supply may be constant, pulsed, modulated, or follow any other voltage function. An excitation stage may include applying an excitation voltage to a Taylor cone emitter for a fixed period.

In some examples, the application of the excitation voltage is short enough so to be considered a pulse (<1 s). In other examples, the signal recorded in the mass spectrometer is attained by applying multiple pulses. In particular examples, the pulse may be either rectangular, triangular, saw-tooth, sinusoidal, or combinations thereof. In particular examples, the voltage may be ramped from a lower voltage up to the excitation voltage. In other examples, the voltage may be ramped from a higher than optimal to the excitation voltage. In additional examples, the excitation stage may comprise multiple combinations of ramping up to and down from the excitation voltage. Excitation voltage may be deprived at any point either electronically, or mechanically, or electromechanically. In preferred examples, the excitation voltage is deprived electromechanically, such as high voltage relay.

Solvent delivery systems may be discrete or continuous. Examples of solvent delivery system include, but are not limited to, a syringe pump, a peristaltic pump, a liquid chromatography pump, a micro droplet solvent dispensing system, an acoustic droplet delivery system, or combinations thereof. An elution solvent delivery system may dispense one or more doses of solvent onto one or more locations of the Taylor cone emitter whereas said doses may be dispensed either discretely or continuously.

The term “solvent aerosol sprayer” should be understood as a synonym of “solvent blaster,” “solvent cloud,” “inlet cleaning system,” “droplet sprayer,” “mist sprayer,” and “venturi sprayer.”

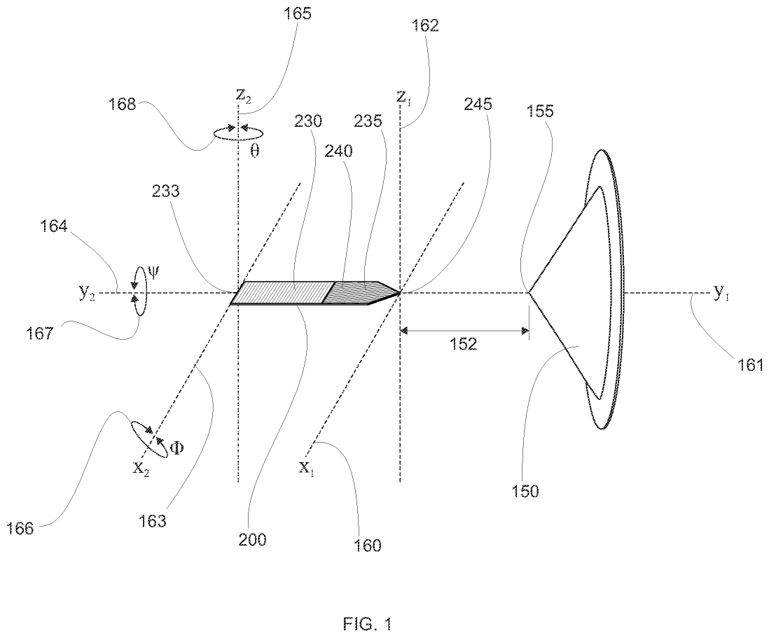

Referring to FIG. 1, in one embodiment, a Taylor cone emitter device 200 is positioned in front of a mass spectrometer inlet (skimmer cone) 150. The Taylor cone emitter device 200 includes a substrate 230 having at least one planar surface 235, a sorbent layer 240 disposed on at least a portion of the at least one planar surface 235, and a tapering tip 245 extending from the substrate 230 toward an analysis end of the Taylor cone emitter device 200. The substrate 230 may have any suitable dimensions, including, but not limited to, about 4 mm wide by about 40 mm long by about 0.5 mm thick. The substrate 230 may be made from any suitable material, including, but not limited to, conductive materials such as, but not limited to, stainless steels. The sorbent layer 240 may include an extraction phase sorbent including, but not limited to, polymeric particles (e.g., silica modified with C18 groups) and a binder (e.g., polyacrylonitrile).

The positioning of a Taylor cone emitter tip 245 is represented by a given a set of coordinates named x₁ 160, y₁ 161 and z₁ 162, and relates to the tip 245 position with respect to the aperture 155 of skimmer cone 150. The ions travel through the skimmer cone 150 and are subsequently analyzed by mass spectrometry. The distance 152 between emitter tip 245 and skimmer cone aperture 150 is the shortest path between the elements a Taylor cone ion flux may travel.

Another cartesian coordinate, x₂ 163, y₂ 164 and z₂ 165, is described with respect to the emitter distal end 233 and relates to the position of planar surface 235 with respect to the skimmer cone 150. The position of planar surface 235 relates to the degree of tilt or level, which is relevant to the ability to effectively receive and retain elution solvent during the Taylor cone production. In cases where the flat surface 235 is absolutely horizontal with respect to ground, the elution solvent is influenced by capillary effects with respect to the sorbent and electroosmotic forces with respect to the applied electric field. In cases where the flat surface 235 is at an angle other than absolutely horizontal, additional gravitational forces may be employed to facilitate liquid retention or flow. The rotation of the Taylor cone emitter device 200 is described on each axis in terms of a set of Euler angles ϕ 166, ψ 167, and θ 168. These additional degrees of movement relate to the planal nature of the flat surface 235. In one particular embodiment, the ideal location of a Taylor cone emitter in terms of X₁Y₁Z₁ coordinates are 0 mm, 5 mm, 0 mm, respectively. Likewise, the coordinates of the emitter receptacle are X₂Y₂Z₂ coordinates are 40 mm, 5 mm, and 0 mm, in regard to the skimmer cone 150. The angel of rotation ϕ on the X dimension is 0° (i.e., absolutely horizontal).

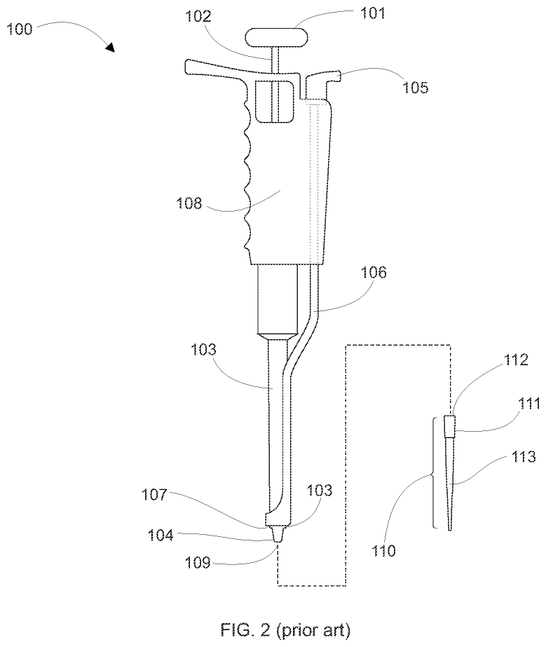

FIG. 2 illustrates a common commercially available manual micropipettor 100. The pipettor is a plunger displacement-based device capable of first drawing liquid into the pipette tip 110 and subsequently dispensing the liquid. The plunger mechanism is not shown and resides in the housing 108 of the pipettor between the plunger shaft 102 and the pipette end 109. Standard micropipette tips 110 are loaded onto the pipettor device 100 by centering the device over the pipette end 109 and tapping the device 100 gently onto the opening of the tip 112. The tip 112 is mounted via friction against the conical outer surface 104 of the pipette end 109 and is ready for use. The operator first depresses the push button 101 and immerses the pipette tip 110 into the liquid of interest. Releasing the push button draws a volume of liquid into the vessel portion 113 of the pipette tip. The liquid is transferred by depressing the push button 101 again, and the liquid is dispensed. Following the desired number of liquid transfer operations, the pipette tip 110 is ejected from the pipettor by depressing the tip ejector button 105. This operation pushes the tip ejector 106 down the length of pipette shaft 103 and the bottom surface of the ejector shaft 107 pushes the pipette tip 110 off the conical outer surface 104 of pipettor end 109. The entire procedure is then repeated as required. While the manual version of the pipette device is shown, automated and robotic versions include the same relevant mechanical elements. The conical shape and dimensions of the pipette end 109, the bottom surface of the ejector shaft 107, and the pipette tip cup 111 are standardized in the art. In one embodiment, the solid phase microextraction devices disclosed herein are adapted to these standardized dimensions in order to interface easily with the installed laboratory equipment.

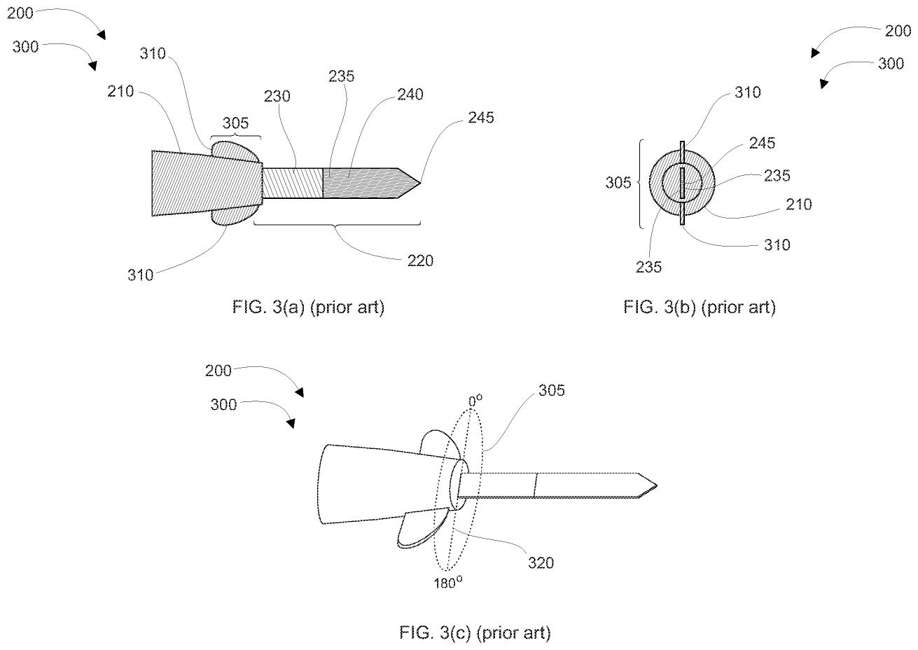

Referring to FIGS. 3(a)-(c), wherein a Taylor cone emitter device 200 is a solid phase microextraction device, the basic elements of the Taylor cone emitter device 200 comprise a substrate 230 having at least one planar surface 235, a sorbent layer 240 disposed on at least a portion of the at least one planar surface 235, a tapering tip 245 extending from the substrate 230 toward an analysis end of the device 200, and a receptacle mount 210 configured for removable attachment to an emplacement of a receiving device. The substrate 230 may have any suitable dimensions, including, but not limited to, about 4 mm wide×about 40 mm long×about 0.5 mm thick. The substrate 230 may be made from any suitable material, including, but not limited to, conductive materials such as, but not limited to, stainless steels. The sorbent layer 240 may include an extraction phase sorbent including, but not limited to, polymeric particles (e.g., silica modified with C18 groups) and a binder (e.g., polyacrylonitrile).

In one embodiment, the Taylor cone emitter device 200 is a CBS device 300 that has been adapted to standard pipette tip dimensions. The blade portion 220 is fitted with a cup as the receptacle mount 210 which is configured to attach to the emplacement 104 on the pipettor end 109. The receptacle mount 210 is fixed to the substrate 230 and is positioned at the opposite end from the sorbent layer 240 and tapering tip 245. The inner surface of the receptacle mount 210 is shaped to employ a friction fit mechanism, consistent with the standard commercial pipette tip cup. The receptacle mount 210 may be made from electrically insulating polymers consistent with standard pipette tips, such as, but not limited to, polypropylene or electrically conductive polymers such as, but not limited to, carbon impregnated polypropylene.

In one embodiment, the Taylor cone emitter device 200 includes a clocking feature 305, which is configured to fix a radial orientation of the planar surface 235 with respect to the receiving device. “Clocking” is intended to connotate the passage of a hand around an analogue clockface as a paradigm for indicating radial orientation of the planar surface 235. In one embodiment, the clocking feature 305 includes at least one of an indentation or a protrusion corresponding to at least one of a complimentary protrusion or complimentary indentation of the receiving device, such that when the Taylor cone emitter device 200 is mounted to the receiving device, the clocking feature 305 limits the radial orientation of the Taylor cone emitter device 200 with respect to the receiving device to a predetermined number of radial positions. The predetermined number of radial positions may consist of a single radial position, two radial positions, or may include any suitable lager number of radial positions. The Taylor cone emitter device 200 may include visual indicia of the radial orientation of the at least one planar surface 235 on the receptacle mount 210. Such visual indicia may serve to indicate the radial orientation of the at least one planar surface 235 when the planar surface 235 itself is not visible.

In one embodiment, the Taylor cone emitter device 200 is a pipettor-compatible CBS device 300, the receptacle mount 210 is a pipette-tip receptacle mount 210, and the emplacement 104 is a pipettor tip emplacement 104 configured to removably engage the pipette tip receptacle mount 210. As used herein, “removable” indicates configuration for removal without damage. The receiving device may be any suitable device, including, but not limited to, a pipettor or a Taylor cone emitter device manipulator.

In one embodiment, the receptacle mount 210 has two fin protrusions 310 extending equidistant from the receptacle mount 210 serving as the clocking feature 305. The presence of the two fin protrusions 310 in this configuration reduces the radial position conditions 320 of the blade to two discreet equivalent positions (i.e., 0° and 180°). The two-fin design depicted here is for illustration purposes; other configurations employing greater or fewer fins may be used, or other features on the receptacle mount 210 may be conceived where the radial rotation of the Taylor cone emitter device 200 is restricted when engaged with an emplacement. In order for the fin protrusions 310 to control radial position, they engage with the receiving device in a lock-and-key arrangement.

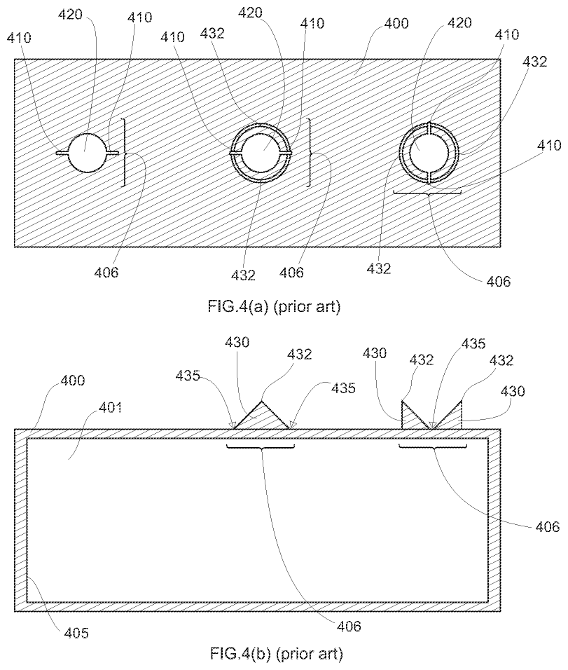

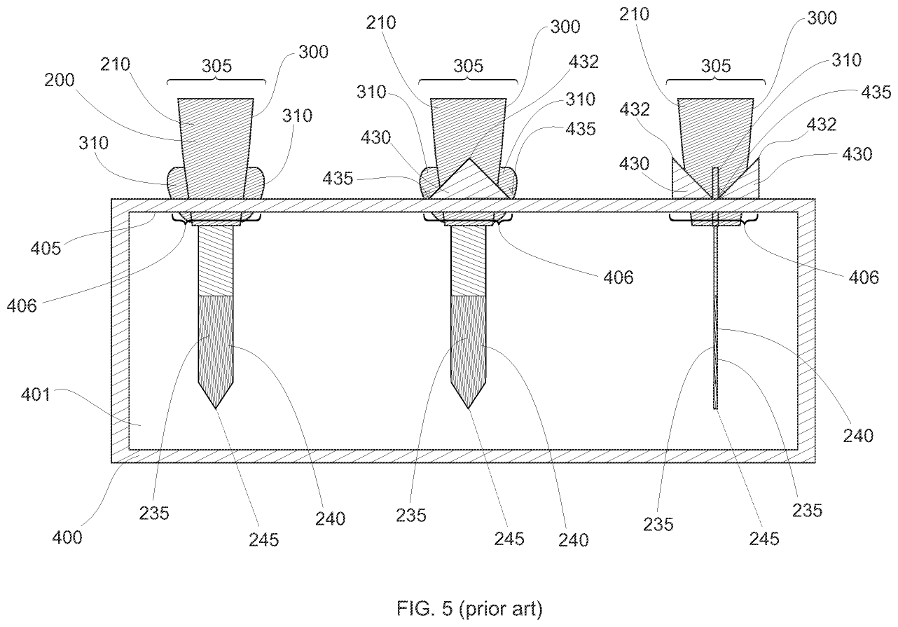

FIGS. 4(a), 4(b), and 5 illustrate a prior Taylor cone emitter device repository 400 which orients the Taylor cone emitter device 200 while it is docked. The Taylor cone emitter device repository 400 includes a repository wall 405 surrounding and defining a chamber 401, a plurality of orifices 420 disposed in the repository wall 405, each configured to receive and retain a substrate 230 and a receptacle mount 210 of a Taylor cone emitter device 200, and a plurality of clocking feature interfaces 406 disposed in the repository wall 405, each configured to guide a clocking feature 305 of the Taylor cone emitter device 200 into a predetermined radial orientation and fix the Taylor cone emitter device 200 in the predetermined radial orientation. The chamber 401 is configured to accept the substrate 230 of the Taylor cone emitter device 200 with the substrate 230 and a tapering tip 245 extending from the substrate 230 being remote from contact with the repository wall 405 or any adjacent Taylor cone emitter devices 200 disposed in the Taylor cone emitter device repository 400.

As depicted, the Taylor cone emitter device repository 400 includes two slits 410 as the clocking feature interfaces 406, radially positioned consistent with clocking feature 305 of the CBS device 300. As depicted, the taper of the blade fins 310 provides an additional mechanism to assist the successful docking of slightly offset CBS devices 300 with respect to the axial center of the tapering tip 245 and the orifices 420 of the Taylor cone emitter device repository 400. As depicted, the clocking feature interface 406 includes guidance protrusions 430 surrounding the orifice 420 to promote proper alignment of CBS 300 when they are docked into the Taylor cone emitter device repository 400. If the CBS device 300 is radially off axis with respect to the orientation of the clocking feature 305 to the clocking feature interface 406, the guidance protrusions 430 are tapered to a point 432 and join to create a valley shape 435 at the base of the orifice 420. The taper of the guidance protrusions 430 provides a mechanism to guide and realign an off-axis CBS device 300 so that it is properly positioned while docked in the Taylor cone emitter device repository 400.

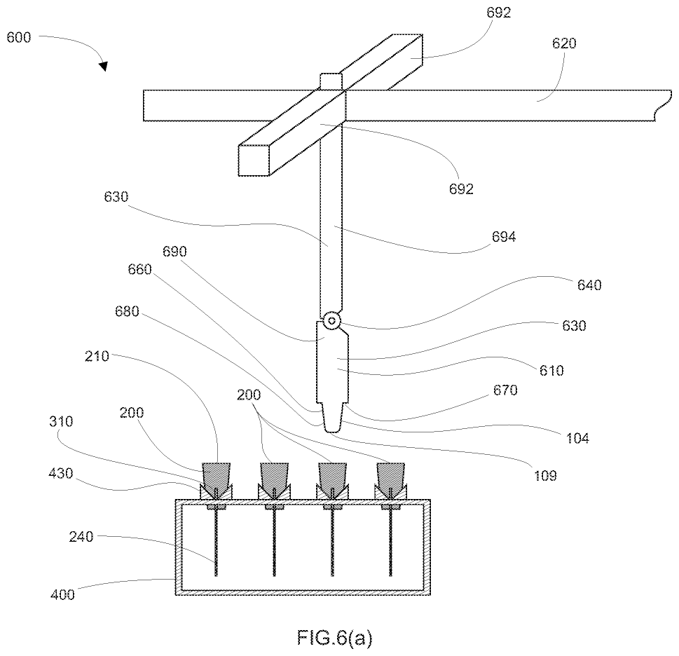

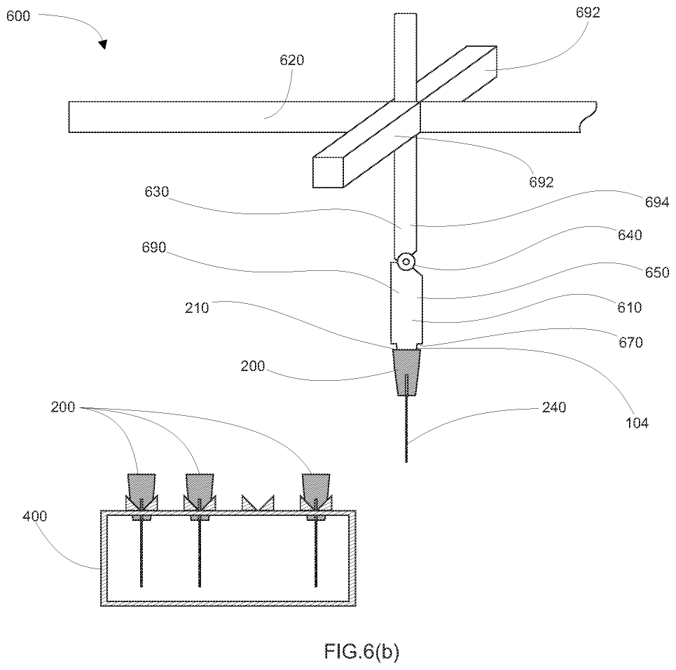

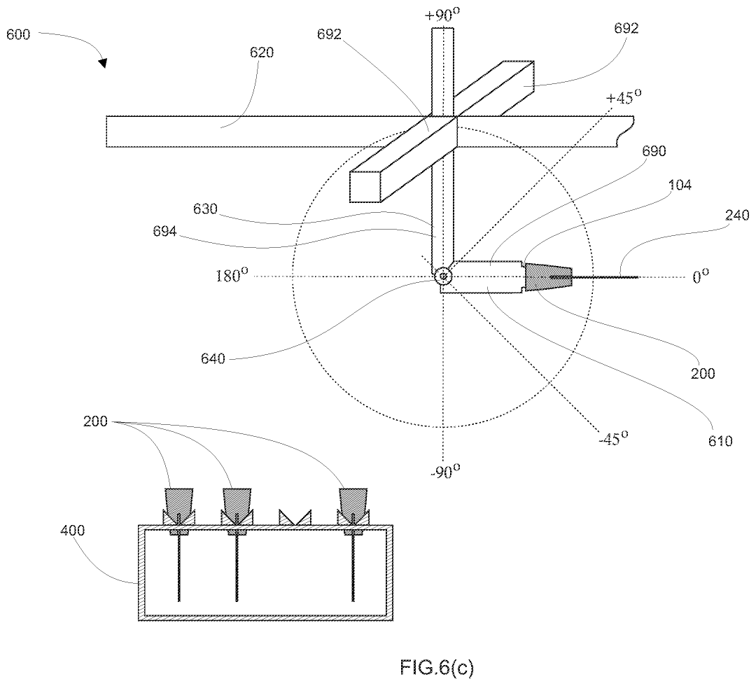

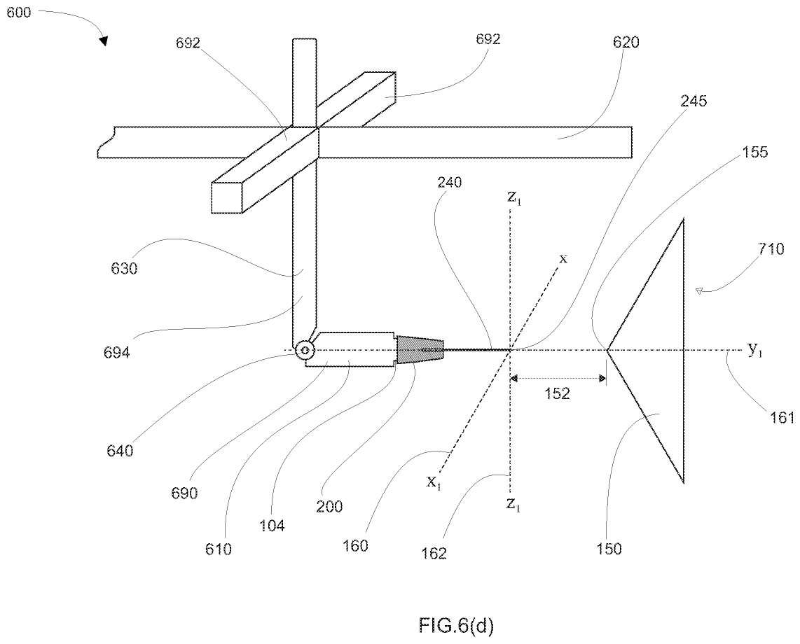

Referring to FIGS. 6(a)-6(d), in one embodiment, a Taylor cone emitter device automated handler 600 includes an actuated Taylor cone emitter device manipulator 610, a first actuator 620 configured to horizontally actuate (along the x axis as shown in FIG. 1) the actuated Taylor cone emitter device manipulator 610, a second actuator 630 configured to vertically actuate (along the y axis as shown in FIG. 1) the actuated Taylor cone emitter device manipulator 610. and a third actuator 640 configured to rotationally actuate the actuated Taylor cone emitter device manipulator 610 between a vertical orientation and a horizontal orientation. Suitable actuators include, but are not limited to, linear actuators, rotary actuators, hydraulic actuators, pneumatic actuators, electric actuators, electromechanical actuators, electrohydraulic actuators, thermal actuators, magnetic actuators, mechanical actuators, supercoiled polymer actuators, hinges, pivot hinges, slider-cranks, eccentric cams, or combinations thereof. The actuators may be independent, but under common control, or may be part of a comprehensive interlinked system, such as a 6-axis robot. The actuated Taylor cone emitter device manipulator 610 includes a shaft 650, an emplacement 660 disposed at an end 109 of the shaft 650. The emplacement 660 is configured to removably engage a receptacle mount 210 of a Taylor cone emitter device 200. The actuated Taylor cone emitter device manipulator 610 further includes an ejector 670 configured to dismount the receptacle mount 210 of the Taylor cone emitter device 200 and a clocking feature interface 680 configured to guide a clocking feature 305 of the Taylor cone emitter device 200 into a predetermined radial orientation and fix the Taylor cone emitter device in the predetermined radial orientation. The Taylor cone emitter device automated handler 600 is configured to mount the Taylor cone emitter device 200 in the vertical orientation, rotate the Taylor cone emitter device 200 to the horizontal orientation, and present the Taylor cone emitter device 200 to an analytical instrument 710.

The emplacement 660 may be any suitable mount, including, but not limited to, a pipettor tip emplacement 104 configured to removably engage a pipette tip receptacle mount 210 as the receptacle mount 210.

In one embodiment, the Taylor cone emitter device 200 is a coated blade spray device 300.

The third actuator 640 may rotationally actuate the actuated Taylor cone emitter device manipulator 610 to any degree between vertical and horizontal, or even past vertical and horizontal. By way of example, a pitch of 45° above or below horizonal may be used to optimize elution solvent delivery and Taylor cone generation.

The Taylor cone emitter device automated handler 600 may further include any suitable number of additional actuators. The Taylor cone emitter device automated handler 600 may include a fourth actuator 690 configured to rotationally actuate the actuated Taylor cone emitter device manipulator 610 about an axis along the shaft (along the y axis as shown in FIG. 1, representing the axis of rotation corresponding to Euler angle ψ 167). The fourth actuator 690 may be configured to rotate the Taylor cone emitter device 200 about the y axis of FIG. 1 so as to align the Taylor cone emitter device 200 with the analytical instrument 710. The Taylor cone emitter device automated handler 600 may include a fifth actuator 692 configured to horizontally actuate the actuated Taylor cone emitter device manipulator 610 orthogonal to the first actuator 620 (along the z axis as shown in FIG. 1). The fifth actuator 692 and the first actuator 620 may be configured to cooperate so as to selectively engage or dismount the Taylor cone emitter device 200 at a predetermined well of a microtiter array tray. The Taylor cone emitter device automated handler 600 may include a sixth actuator 694 configured to rotationally actuate the actuated Taylor cone emitter device manipulator 610 about an axis about the y axis as shown in FIG. 1, representing the axis of rotation corresponding to Euler angles θ 168, which may be used to guide the Taylor cone emitter device 200 to any one of a selection of analytical device at different position. A Taylor cone emitter device automated handler 600 may include any combination of the fourth actuator 690, the fifth actuator 692, and the sixth actuator 694.

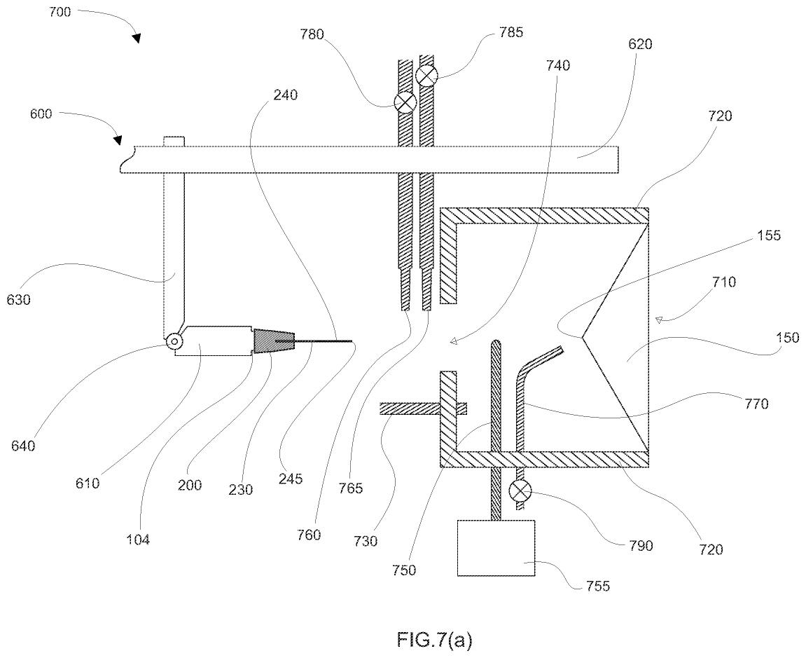

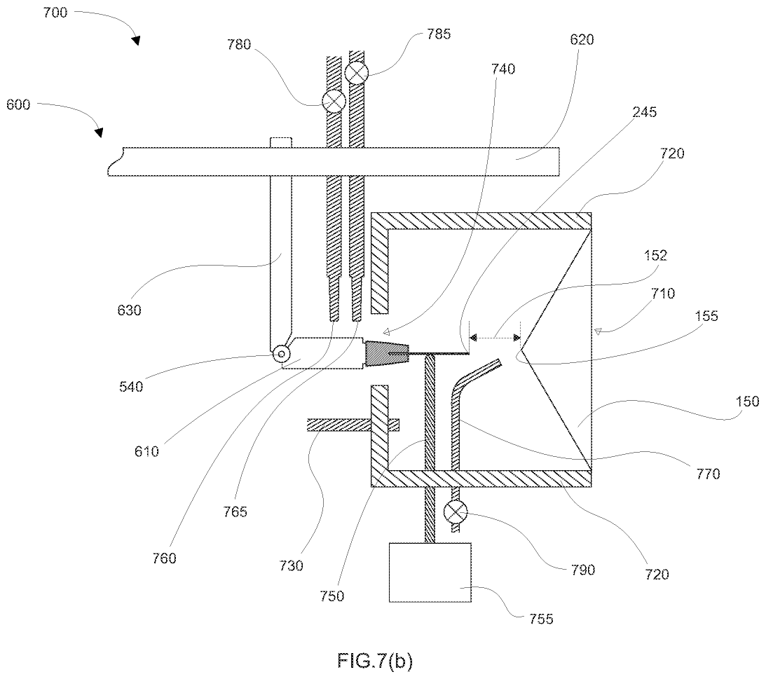

Referring to FIGS. 7(a)-(b), in one embodiment, a Taylor cone emitter device automated handling system 700 includes an analytical instrument 710 having a sample inlet 150, a sample loading antechamber 720 mounted to the analytical instrument 710 such that the sample inlet 150 of the analytical instrument 710 is covered by the sample loading antechamber 720, and a Taylor cone emitter device automated handler 600. The sample loading antechamber 720 includes a gas purge 730 configured to fill the sample loading antechamber 720 with an inert atmosphere (including, but not limited to, dry nitrogen, noble gases, or combinations there), a sample aperture 740 configured to receive a Taylor cone emitter device 200, and a high voltage power electrode 750 connected to a high voltage power supply 755 and disposed within the sample loading antechamber 720 and configured to contact the Taylor cone emitter device 200 when the Taylor cone emitter device 200 is in a predetermined position and orientation relative to the sample inlet 150 of the analytical instrument 710. The Taylor cone emitter device automated handler 600 is configured to insert the Taylor cone emitter device 200 into the sample loading antechamber 720 through the sample aperture 740 to present the Taylor cone emitter device 200 to the sample inlet 150 of the analytical instrument 710.

The Taylor cone emitter device automated handling system 700 may further include a first elution solvent dispenser 760 disposed external to the sample loading antechamber 720 and configured to apply a first elution solvent to the Taylor cone emitter device 200 while the Taylor cone emitter device 200 is in the horizontal orientation. The Taylor cone emitter device automated handling system 700 may further include a second elution solvent dispenser 765 disposed external to the sample loading antechamber 720 and configured to apply a second elution solvent to the Taylor cone emitter device 200 while the Taylor cone emitter device 200 is in the horizontal orientation. The first elution solvent dispenser 760 and the second elution solvent dispenser 765, if present, may be operated with first liquid control device 780 and second liquid control device 785, respectively.

The analytical instrument 710 may be a mass spectrometer and the sample inlet 150 may be a mass spectrometer inlet.

The gas purge 730 filling the sample loading antechamber 720 with an inert atmosphere of the inert gas in the sample loading antechamber 720 may maintain a predetermined humidity and sweep the sample loading antechamber 720 of any chemical contaminants.

The Taylor cone emitter device automated handling system 700 may further include a solvent aerosol dispenser 770 extending into the sample loading antechamber 720 configured to apply a solvent aerosol to the sample inlet 150 of the analytical instrument 710. The solvent aerosol dispenser 770 may be operated with solvent control device 790.

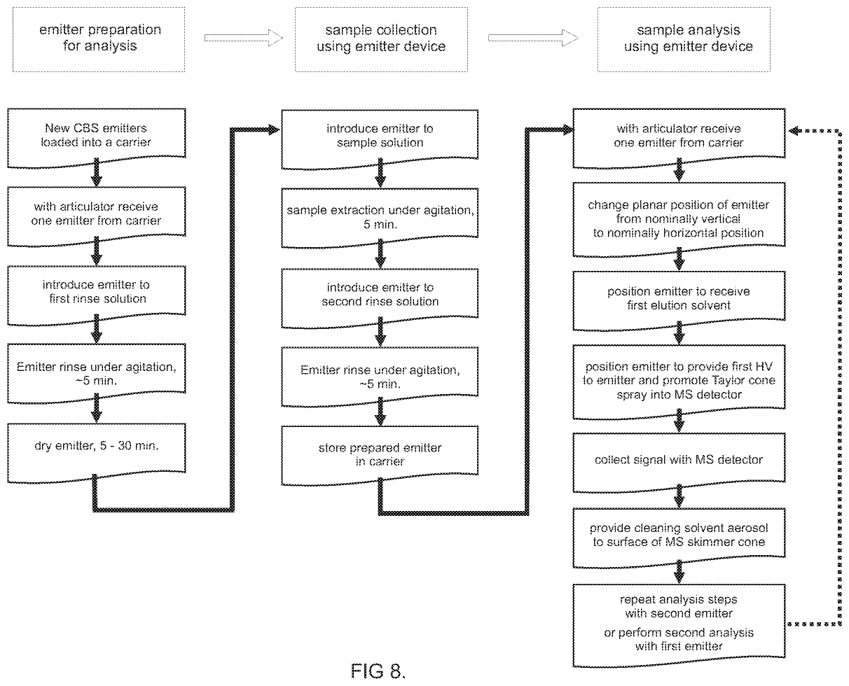

Referring to FIGS. 7(a), 7(b), and 8, in one embodiment, a method for analyzing a sample includes mounting a Taylor cone emitter device 200 in a vertical orientation to a Taylor cone emitter device automated handler 600, rotating the Taylor cone emitter device 200 to the horizontal orientation, inserting the Taylor cone emitter device 200 into a sample loading antechamber 720 through a sample aperture 740 of the sample loading antechamber 720, presenting the Taylor cone emitter device 200 to the sample inlet 150 of the analytical instrument 710 at a predetermined position and orientation relative to the sample inlet 150 of the analytical instrument 710, energizing the high voltage power electrode 750 in contact with the Taylor cone emitter device 200, collecting ions generated from the Taylor cone emitter device through the sample inlet 150 of the analytical instrument 710, analyzing the collected ions with the analytical instrument 710, and removing the Taylor cone emitter device 200 from the sample loading antechamber 720.

The method may further include cleaning the sample inlet 150 by applying a solvent aerosol to the sample inlet 150 of the analytical instrument 710 through the solvent aerosol dispenser 770. The solvent aerosol dispenser may deliver a mist of droplets at the sample inlet 150 so as to remove matter lingering on thereon. This may reduce the chances of false positives or reduction on the instrumental performance. The aerosol dispenser 770 may operate under a Venturi effect.

### EXAMPLES

An automated system capable of performing the sample collection and sample analysis stages of a CBS workflow was made from an Opentrons OT2 liquid handling robot, attached to a Thermo Fisher TSQ Altis mass spectrometer. The CBS interface was a laboratory built system similar to that described in FIGS. 7(a)-(b). A laboratory-built robot pipettor capable of rotating the emitter into a nominally horizontal position was also made.

### Experiment 1: Instrument Carry-Over Without Cleaning Aerosol System

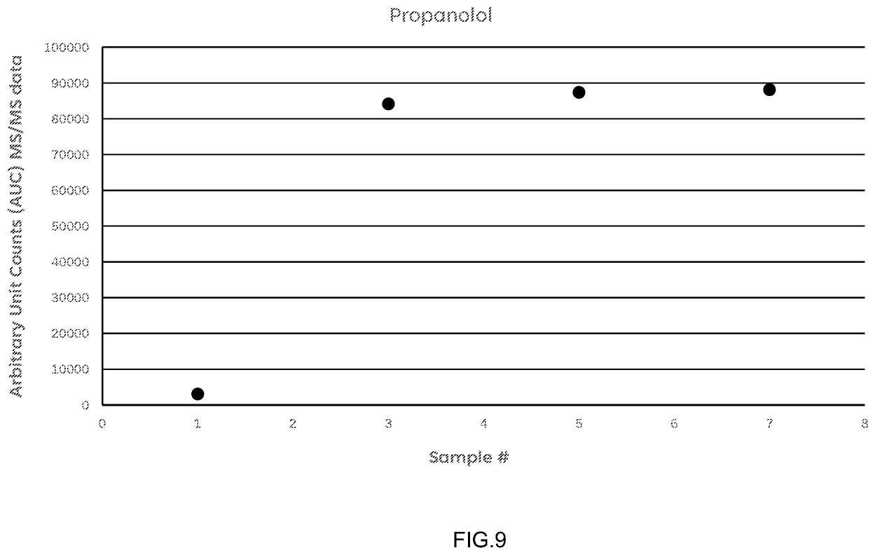

Blank signals collected after intercalated injections of samples containing 25,000 ng/ml of propranolol are presented in FIG. 9.

The analytical workflow comprised the following steps:

### Sample Preparation

1. HLB coated blades on a nominal vertical position were pre-cleaned by immersing them on 300 μL of a MeOH:IPA:ACN solution for 5 min at 1,000 rpm.
2. Then, 200 μL of plasma sample containing 25,000 ng/ml of propranolol were delivered on a well plate and 100 μL of matrix modifier (buffer 95:5 Water:ACN, 1.4% FA) containing the internal standard was added on top of the plasma sample and shake for 5 min at 1,000 rpm.
3. Then, pre-cleaned CBS devices on a nominal vertical position were immersed on the sample-buffer mix for 5 min and agitated at 1,000 rpm.
4. Finally, the CBS devices on a nominal vertical position were immersed for 10 s on a separate well plate containing LC-MS water for rinsing the coating.

### Elution/Ionization Sequence

5. After analyte collection, a CBS device containing the analyte of interest on a nominal horizontal position was presented to the inlet of a Thermo TSQ Altis at optimum XYZ distance from the inlet.
6. Then, 7.5 μL of a 95:5 methanol:water 0.1% FA solution was added by the solvent delivery system to the coated area of the device and, after 5 seconds, a high-voltage differential potential was applied to the non-coated area of the blade for 5 seconds to generate an electrospray from the tip of the blade.
7. After spray event was completed, the interface cleaned the MS-inlet prior to the next injection.

### Quantitative Analysis

8. Data analysis was performed using TraceFinder 5.0 and the area under the curve for the entire ion chronogram was integrated (i.e., 5 s spray event) unless otherwise stated.

As can be seen in FIG. 9, the instrumental response for a sample blank was no longer consistent with a typical blank signal in cases where the blank sample was injected right after a blade that was utilized to collect the target analyte form a highly concentrated sample (e.g., 5,000 ng/mL of MTX). As may be seen, there is an increment of 27 times between injection number 1 (blank) and injection number 2 (blank after highly concentrated sample). Furthermore, it was observed that if highly concentrated samples were injected intercalated after blank samples, aid “blank” signal did not return to the original threshold.

### Experiment 2: Instrument Carry-Over With Cleaning Aerosol System

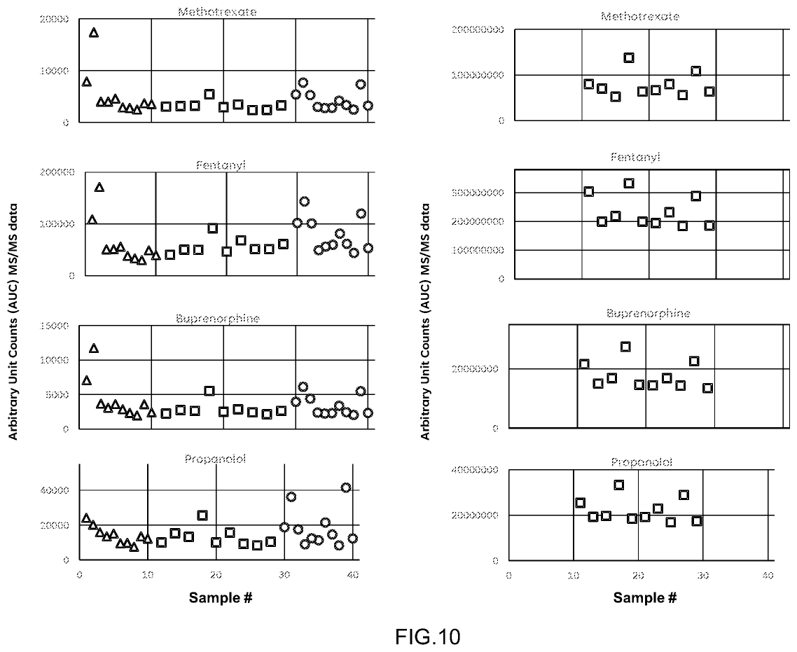

FIG. 10 presents blank signals obtained before (triangles), during (squares), and after (circles) injection of 10 highly concentrated samples comprising the following compounds: methotrexate, fentanyl, buprenorphine and propranolol (namely 5,000 ng/ml, 3,000 ng/ml, 10,000, and 1,500 ng/mL, respectively). A solvent aerosol sprayer was used after every injection to clean residues of analyte lingering at the inlet after every injection.

TABLE 1
P-Values

| Compound | Methotrexate | Fentanyl | Buprenorphine | Propranolol |
|---|---|---|---|---|
| P(T <= t) | 0.24 | 0.21 | 0.20 | 0.15 |
| one-tail | | | | |
| P critical | 0.05 | 0.05 | 0.05 | 0.05 |

Table 1 displays the probability (based on a one-tail t-test assuming unequal variance) that the blanks acquired before (triangles) are different from those acquired after (circles) the injection of 10 intercalated highly concentrated samples. As can be seen in Table 1, given that the P-value is not less than 0.05, the differences between blank injections are not considered to be statistically significant. A solvent aerosol sprayer was used after every injection to clean residues of analyte lingering at the inlet after every injection.

Although instrument carry-over was not previously recognized for direct-to-MS and AMS, it is certainly a criterion that could hamper the implementation of any sans-chromatography technology in real clinical and forensic settings as it may lead to a significant amount of false positives. Understanding that there could be no instrumental carry-over due to CBS devices where the CBS blades were not reutilized, it has been discovered that the other potential source of instrumental signal were analytes lingering at the MS inlet from previous injection(s). Aiming to solve this problem, analyte lingering at the entrance of the MS was cleaned, in less than 2 seconds, using an inlet cleaning system. As can be seen in FIG. 10 and Table 1, the experimental results demonstrate that blank signals before and after highly concentrated samples were statistically identical.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A Taylor cone emitter device automated handler, comprising:
an actuated Taylor cone emitter device manipulator, including:
a shaft;
an emplacement disposed at an end of the shaft, the emplacement being configured to removably engage a receptacle mount of a Taylor cone emitter device;
an ejector configured to dismount the receptacle mount of the Taylor cone emitter device; and
a clocking feature interface configured to guide a clocking feature of the Taylor cone emitter device into a predetermined radial orientation and fix the Taylor cone emitter device in the predetermined radial orientation;
a first actuator configured to horizontally actuate the actuated Taylor cone emitter device manipulator;
a second actuator configured to vertically actuate the actuated Taylor cone emitter device manipulator; and
a third actuator configured to rotationally actuate the actuated Taylor cone emitter device manipulator between a vertical orientation and a horizontal orientation,
wherein the Taylor cone emitter device automated handler is configured to mount the Taylor cone emitter device in the vertical orientation, rotate the Taylor cone emitter device to the horizontal orientation, and present the Taylor cone emitter device to an analytical instrument.

2. The Taylor cone emitter device automated handler of claim 1, wherein the emplacement is a pipettor tip emplacement configured to removably engage a pipette tip receptacle mount as the receptacle mount.

3. The Taylor cone emitter device automated handler of claim 1, wherein the Taylor cone emitter device is a coated blade spray device.

4. The Taylor cone emitter device automated handler of claim 1, further including a fourth actuator configured to rotationally actuate the actuated Taylor cone emitter device manipulator about an axis along the shaft.

5. The Taylor cone emitter device automated handler of claim 4, wherein the Taylor cone emitter device automated handler is configured to rotate the Taylor cone emitter device about the axis along the shaft of the actuated Taylor cone emitter device manipulator so as to align the Taylor cone emitter device with the analytical instrument.

6. The Taylor cone emitter device automated handler of claim 1, further including a fifth actuator configured to horizontally actuate the actuated Taylor cone emitter device manipulator orthogonal to the first actuator.

7. The Taylor cone emitter device automated handler of claim 6, wherein the fifth actuator and the first actuator are configured to cooperate so as to selectively engage or dismount the Taylor cone emitter device at a predetermined well of a microtiter array tray.

8. A Taylor cone emitter device automated handling system, comprising:
an analytical instrument having a sample inlet;
a sample loading antechamber mounted to the analytical instrument such that the sample inlet of the analytical instrument is covered by the sample loading antechamber, the sample loading antechamber including:
a gas purge configured to fill the sample loading antechamber with an inert atmosphere;
a sample aperture configured to receive a Taylor cone emitter device; and
a high voltage power electrode disposed within the sample loading antechamber and configured to contact the Taylor cone emitter device when the Taylor cone emitter device is in a predetermined position and orientation relative to the sample inlet of the analytical instrument; and
a Taylor cone emitter device automated handler, comprising:
an actuated Taylor cone emitter device manipulator, including:
a shaft;
an emplacement disposed at an end of the shaft, the emplacement being configured to removably engage a receptacle mount of the Taylor cone emitter device;
an ejector configured to dismount the receptacle mount of the Taylor cone emitter device; and
a clocking feature interface configured to guide a clocking feature of the Taylor cone emitter device into a predetermined radial orientation and fix the Taylor cone emitter device in the predetermined radial orientation;
a first actuator configured to horizontally actuate the actuated Taylor cone emitter device manipulator;
a second actuator configured to vertically actuate the actuated Taylor cone emitter device manipulator; and
a third actuator configured to rotationally actuate the actuated Taylor cone emitter device manipulator between a vertical orientation and a horizontal orientation,
wherein the Taylor cone emitter device automated handler is configured to:
mount the Taylor cone emitter device in the vertical orientation;
rotate the Taylor cone emitter device to the horizontal orientation;
insert the Taylor cone emitter device into the sample loading antechamber through the sample aperture; and
present the Taylor cone emitter device to the sample inlet of the analytical instrument.

9. The Taylor cone emitter device automated handling system of claim 8, wherein the emplacement is a pipettor tip emplacement configured to removably engage a pipette tip receptacle mount as the receptacle mount.

10. The Taylor cone emitter device automated handling system of claim 8, wherein the Taylor cone emitter device is a coated blade spray device.

11. The Taylor cone emitter device automated handling system of claim 8, further including a fourth actuator configured to rotationally actuate the actuated Taylor cone emitter device manipulator about an axis along the shaft.

12. The Taylor cone emitter device automated handling system of claim 11, wherein the Taylor cone emitter device automated handler is configured to rotate the Taylor cone emitter device about the axis along the shaft of the actuated Taylor cone emitter device manipulator so as to align the Taylor cone emitter device with the analytical instrument.

13. The Taylor cone emitter device automated handling system of claim 8, further including a fifth actuator configured to horizontally actuate the actuated Taylor cone emitter device manipulator orthogonal to the first actuator.

14. The Taylor cone emitter device automated handling system of claim 13, wherein the fifth actuator and the first actuator are configured to cooperate so as to selectively engage or dismount the Taylor cone emitter device at a predetermined well of a microtiter array tray.

15. The Taylor cone emitter device automated handling system of claim 8, further including a first elution solvent dispenser disposed external to the sample loading antechamber and configured to apply a first elution solvent to the Taylor cone emitter device while the Taylor cone emitter device is in the horizontal orientation.

16. The Taylor cone emitter device automated handling system of claim 15, further including a second elution solvent dispenser disposed external to the sample loading antechamber and configured to apply a second elution solvent to the Taylor cone emitter device while the Taylor cone emitter device is in the horizontal orientation.

17. The Taylor cone emitter device automated handling system of claim 8, wherein the analytical instrument is a mass spectrometer and the sample inlet is a mass spectrometer inlet.

18. The Taylor cone emitter device automated handling system of claim 8, wherein the sample loading antechamber further includes a solvent aerosol dispenser configured to apply a solvent aerosol to the sample inlet of the analytical instrument.

19. A method for analyzing a sample, comprising:
mounting a Taylor cone emitter device in a vertical orientation to a Taylor cone emitter device automated handler, the Taylor cone emitter device automated handler including:
an actuated Taylor cone emitter device manipulator, including:
a shaft;
an emplacement disposed at an end of the shaft, the emplacement being configured to removably engage a receptacle mount of the Taylor cone emitter device;
an ejector configured to dismount the receptacle mount of the Taylor cone emitter device; and
a clocking feature interface configured to guide a clocking feature of the Taylor cone emitter device into a predetermined radial orientation and fix the Taylor cone emitter device in the predetermined radial orientation;
a first actuator configured to horizontally actuate the actuated Taylor cone emitter device manipulator;
a second actuator configured to vertically actuate the actuated Taylor cone emitter device manipulator; and
a third actuator configured to rotationally actuate the actuated Taylor cone emitter device manipulator between the vertical orientation and a horizontal orientation;
rotating the Taylor cone emitter device to the horizontal orientation;
inserting the Taylor cone emitter device into a sample loading antechamber through a sample aperture of the sample loading antechamber, the sample loading antechamber being mounted to an analytical instrument such that a sample inlet of the analytical instrument is covered by the sample loading antechamber, the sample loading antechamber including:
a gas purge configured to fill the sample loading antechamber with an inert atmosphere;
the sample aperture configured to receive the Taylor cone emitter device; and
a high voltage power electrode disposed within the sample loading antechamber and configured to contact the Taylor cone emitter device when the Taylor cone emitter device is in a predetermined position and orientation relative to the sample inlet of the analytical instrument;
presenting the Taylor cone emitter device to the sample inlet of the analytical instrument at the predetermined position and orientation relative to the sample inlet of the analytical instrument;
energizing the high voltage power electrode in contact with the Taylor cone emitter device;
collecting ions generated from the Taylor cone emitter device through the sample inlet of the analytical instrument;
analyzing the collected ions with the analytical instrument; and
removing the Taylor cone emitter device from the sample loading antechamber.

20. The method of claim 19, wherein the sample loading antechamber further includes a solvent aerosol dispenser, the method further including cleaning the sample inlet by applying a solvent aerosol to the sample inlet of the analytical instrument through the solvent aerosol dispenser.
